(19) United States
(12) Patent Application Publication
(10) Pub. No.: US 2013/0044505 A1
(43) Pub. Date: Feb. 21, 2013

(54) ILLUMINATION APPARATUS

(71) Applicants: Zhi-Ting Ye, Miaoli County (TW); Chin-Liang Chen, Taichung City (TW); Ming-Chuan Lin, Taichung City (TW)

(72) Inventors: Zhi-Ting Ye, Miaoli County (TW); Chin-Liang Chen, Taichung City (TW); Ming-Chuan Lin, Taichung City (TW)

(73) Assignee: WINTEK CORPORATION, Taichung City (TW)

(21) Appl. No.: 13/586,870

(22) Filed: Aug. 16, 2012

(30) Foreign Application Priority Data
Aug. 19, 2011 (TW) 100129774
Jun. 15, 2012 (TW) 101121570

(51) Int. Cl. F21V 8/00

(52) U.S. Cl. 362/555

(57) ABSTRACT

An illumination apparatus includes a light-guiding pillar, a sleeve, and a point light source. The light-guiding pillar has a light-emitting surface, a bottom surface, a light incident surface, and a reflection bar disposed on the bottom surface. An extension direction of the reflection bar is parallel to an extension direction of the light-guiding pillar. The light incident surface of the light-guiding pillar is disposed in the sleeve. The sleeve includes a reflection portion surrounding the light incident surface and extending along a direction away from the light-guiding pillar. An internal diameter of the reflection portion decreases in a direction away from the light incident surface. The portion of the light beams emitted by the point light source are reflected to the light incident surface by an inner surface of the reflection portion and enter the light-guiding pillar.

### CROSS-REFERENCE TO RELATED APPLICATION

This application claims the priority benefit of Taiwan application serial no. 100129774, filed on Aug. 19, 2011 and Taiwan application serial no. 101121570, filed on Jun. 15, 2012. The entirety of each of the above-mentioned patent applications is hereby incorporated by reference herein and made a part of this specification.

### BACKGROUND OF THE INVENTION

1. Field of Invention

The invention relates to an illumination apparatus. More particularly, the invention relates to an illumination apparatus that includes a light-guiding pillar.

2. Background of the Invention

With the progress in semiconductor technology, the power attained by a light-emitting diode (LED) becomes increasingly larger, and so does the intensity of the light emitted from the LED. Owing to the advantages of reduced power consumption, long service life, being environmentally friendly, short start-up time, small volume, and so on, the LEDs have been extensively applied in illumination apparatuses.

The LED is a point light source. When the point light source is applied for normal illumination purposes, the direct vision of the point light source easily causes discomfort or even harm to human eyes, i.e., the point-light-source-glare problem may occur. In order to resolve this issue, two LEDs have been respectively placed at two ends of a light-guiding pillar according to the related art to disperse the light beams respectively emitted by the two LEDs, and thereby the LEDs may serve as the light sources of the illumination apparatus. Nevertheless, if a user intends to use an illumination apparatus with a relatively large illumination range, the light-guiding pillar is inevitably required to be lengthened. The extension of the length of the light-guiding pillar leads to an increase in the distance from the center of the light-guiding pillar to the LEDs at two ends of the light-guiding pillar. Namely, the transmission path of light from the LEDs to the center of the light-guiding pillar is lengthened, thus resulting in the issue of dark zones (i.e., non-uniformity of illumination) around the center of the light-guiding pillar.

### SUMMARY OF THE INVENTION

In view of the above, the invention is directed to an illumination apparatus with favorable illuminance uniformity.

In an embodiment of the invention, an illumination apparatus that includes a light-guiding pillar, at least one sleeve, and at least one point light source is provided. The light-guiding pillar has a light-emitting surface, a bottom surface opposite to the light-emitting surface, at least one light incident surface adjoining the light-emitting surface and the bottom surface, and a reflection bar disposed on the bottom surface. An extension direction of the reflection bar is substantially parallel to an extension direction of the light-guiding pillar. The light incident surface of the light-guiding pillar is disposed in the sleeve. The sleeve includes a reflection portion. The reflection portion surrounds the light incident surface and extends along a direction away from the light-guiding pillar. An internal diameter of the reflection portion decreases in a direction away from the light incident surface. The point light source is suitable for emitting a plurality of light beams. A portion of the light beams are reflected to the light incident surface by an inner surface of the reflection portion and enter the light-guiding pillar. The light beams are reflected by the reflection bar and leave the light-guiding pillar from the light-emitting surface.

In an embodiment of the invention, an illumination apparatus that includes a light-guiding pillar, a first sleeve, a second sleeve, a first point light source, and a second point light source is provided. The light-guiding pillar has a light-emitting surface, a bottom surface opposite to the light-emitting surface, a first and second light incident surfaces adjoining the light-emitting surface and the bottom surface, and a reflection bar disposed on the bottom surface. The first light incident surface is opposite to the second light incident surface. An extension direction of the reflection bar is substantially parallel to an extension direction of the light-guiding pillar. The first light incident surface of the light-guiding pillar is disposed in the first sleeve. The first sleeve includes a first reflection portion. The first reflection portion surrounds the first light incident surface and extends along a direction away from the light-guiding pillar. An internal diameter of the first reflection portion decreases in a direction away from the first light incident surface. The second light incident surface of the light-guiding pillar is disposed in the second sleeve. The second sleeve includes a second reflection portion. The second reflection portion surrounds the second light incident surface and extends along a direction away from the light-guiding pillar. An internal diameter of the second reflection portion decreases in a direction away from the second light incident surface. The first point light source is suitable for emitting a plurality of first light beams. A portion of the first light beams are reflected to the first light incident surface by an inner surface of the first reflection portion and enter the light-guiding pillar. The first light beams are reflected by the reflection bar and leave the light-guiding pillar from the light-emitting surface. The second point light source is suitable for emitting a plurality of second light beams. A portion of the second light beams are reflected to the second light incident surface by an inner surface of the second reflection portion and enter the light-guiding pillar. The second light beams are reflected by the reflection bar and leave the light-guiding pillar from the light-emitting surface.

As described above, in the illumination apparatus of an embodiment of the invention, the reflection portion of the sleeve is conducive to reduction of the dispersion degree of a portion of the light beams, and thereby the light beams may enter the light incident surface of the light-guiding pillar at a relatively small incident angle. As such, a portion of the light beams are more likely to leave the light-guiding pillar from a region far away from the light incident surface, and thereby the illuminance uniformity of the illumination apparatus may be enhanced.

Several exemplary embodiments accompanied with figures are described in detail below to further explain the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic view illustrating an illumination apparatus according to a first embodiment of the invention.

FIG. 2 is a schematic side view illustrating the sleeve depicted in FIG. 1.

FIG. 3A schematically illustrates illuminance distribution of a conventional illumination apparatus.

FIG. 3B schematically and correspondingly illustrates the illuminance distribution along the line segment A1 depicted in FIG. 3A.

FIG. 4A schematically illustrates illuminance distribution of an illumination apparatus according to a first embodiment of the invention.

FIG. 4B schematically and correspondingly illustrates the illuminance distribution along the line segment A2 depicted in FIG. 4A.

FIG. 5 is a schematic view illustrating an illumination apparatus according to a second embodiment of the invention.

FIG. 6 is a cross-sectional view illustrating the illumination apparatus depicted in FIG. 1.

FIG. 7 illustrates light pattern distribution of an illumination apparatus according to a comparison example.

FIG. 8 illustrates light pattern distribution of an illumination apparatus according to an embodiment of the invention.

### DETAILED DESCRIPTION OF DISCLOSED EXEMPLARY EMBODIMENTS

### First Embodiment

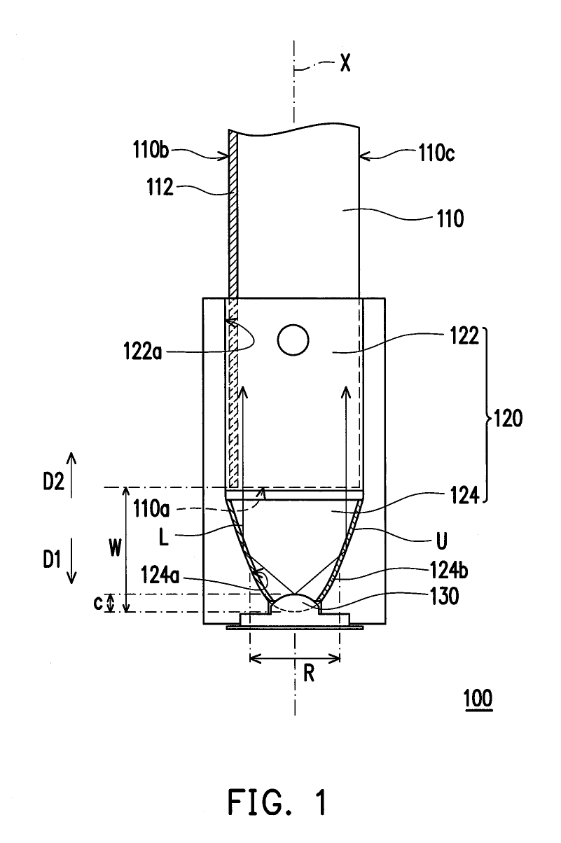

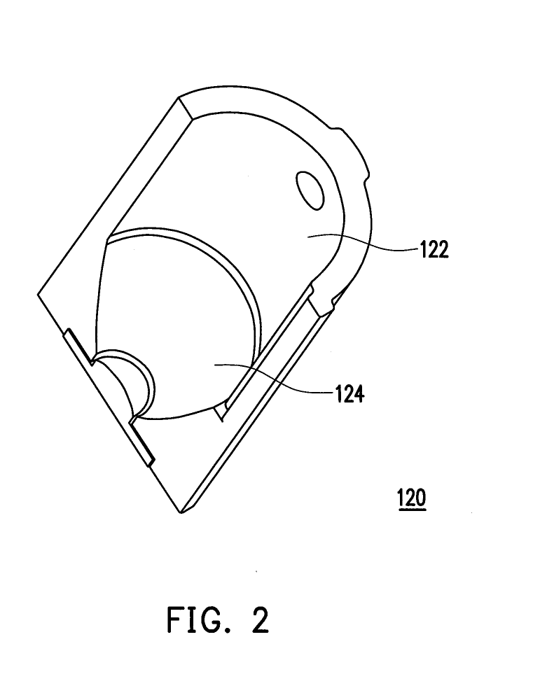

FIG. 1 is a schematic view illustrating an illumination apparatus according to a first embodiment of the invention. FIG. 2 is a schematic side view illustrating the sleeve depicted in FIG. 1. With reference to FIG. 1 and FIG. 2, the illumination apparatus 100 described in the present embodiment includes a light-guiding pillar 110, a sleeve 120, and a point light source 130 suitable for emitting a plurality of light beams L.

The light-guiding pillar 110 has a light incident surface 110a, and the light beams L may enter the light-guiding pillar 110 from the light incident surface 110a. The light-guiding pillar of the present embodiment further has a bottom surface 110b, a light-emitting surface 110c opposite to the bottom surface 110b, and a reflection bar 112 disposed on the bottom surface 110b. An extension direction of the reflection bar 112 is substantially parallel to an extension direction of the light-guiding pillar 110. The reflection bar 112 may destroy the total internal reflection of the light beams L within the light-guiding pillar 110 and further allow the light beams L to leave the light-guiding pillar 110 from the light-emitting surface 110c. In the present embodiment, the light-guiding pillar 110 may be a cylinder and may be made of a transparent material, e.g., polycarbonate (PC), acrylic, resin, or any other transparent material. However, the invention is not limited thereto, and the shape and the material of the light-guiding pillar 110 may be properly adjusted based on actual requirements. According to the present embodiment, the length K of the light-guiding pillar 110 may be greater than or substantially equal to 50 cm.

The light incident surface 110a of the light-guiding pillar 110 is disposed in the sleeve 120. Specifically, the sleeve 120 described herein includes a coupling portion 122 and a reflection portion 124 connected to the coupling portion 122. The light-guiding pillar 110 is disposed in the coupling portion 122, and the reflection portion 124 surrounds the light incident surface 110a and extends along a direction D1 away from the light-guiding pillar 110. Namely, the coupling portion 122 of the present embodiment may be shaped as a circular tube and may encircle an end of the light-guiding pillar 110, and at least a portion of the reflection portion 124 is not in contact with the light-guiding pillar 110 but extends toward the point light source 130. In the present embodiment, the reflection portion 124 is a portion of the sleeve 120 and is thus made of the material of the sleeve 120, e.g., white plastic. In addition, the sleeve 120 described in the present embodiment may preferably include a metal reflection layer. Here, the metal reflection layer 124b may cover the entire inner surface 124a of the reflection portion 124 to enhance the reflection effect of the reflection portion. The metal reflection layer 124b may also further cover the inner surface 122a of the coupling portion 122. According to the present embodiment, the metal reflection layer 124b is made of silver, aluminum, and so on, which should not be construed as a limitation to the invention. That is, the material of the metal reflection layer 124b may be modified based on actual requirements.

Note that the internal diameter R of the reflection portion 124 of the sleeve 120 decreases in a direction away from the light incident surface 110a. Through the reflection portion 124 having the internal diameter R that decreases in a direction away from the light incident surface 110a, the illumination apparatus 100 described in the present embodiment may converge a portion of the light beams L emitted from the point light source 130, such that the light beams L enter the light-guiding pillar 110 at a relatively small incident angle. Thereby, the transmission distance of the light beams L within the light-guiding pillar 110 is more likely to be increased, and thus the light beams L may leave the light-guiding pillar 110 through a region of the light-emitting surface 110c which is relatively far away from the light incident surface 110a. At the same time, other portions of light beams L may still leave the light-guiding pillar 110 through a region of the light-emitting surface 110c which is relatively close to the light incident surface 110a. Therefore, the illuminance uniformity of the illumination apparatus 100 described herein may be enhanced.

For instance, the reflection portion 124 described in the present embodiment may be a curved surface that surrounds the light incident surface 110a, and the metal reflection layer 124b covers the inner surface 124a of the reflection portion 124. In particular, according to the present embodiment, a cross-sectional line obtained by cutting the reflection portion 124 with a reference plane is a portion of a parabola U. The reference plane (not shown) refers to a plane where an axis center X of the light-guiding pillar 110 is located. The axis center X of the light-guiding pillar 110 is substantially parallel to the extension direction of the light-guiding pillar 110 and is overlapped with a light axis of the point light source 130. That is, the reflection portion 124 maybe a portion of a curved surface formed by rotating the parabola U around the axis center X to form a curved surface, and the reflection portion 124 described herein may be a portion of the curved surface. However, the invention is not limited thereto, and the reflection portion 124 in another embodiment of the invention may be a hollow polyhedral pyramid constituted by a plurality of planes, and a bottom surface of the hollow polyhedral pyramid has an opening that exposes the light incident surface 110a.

The point light source 130 described in the present embodiment may be located at a focal point of the parabola U. Thereby, after the light beams L emitted from the point light source 130 are reflected by the metal reflection layer 124b on the inner surface 124a of the reflection portion 124, a moving direction D2 of the light beams L may be parallel to the symmetrical axis of the parabola U (i.e., the axis center X of the light-guiding pillar 110), and the light beams L may be transmitted to the light incident surface 110a at an incident angle close to 0°. This may further ensure the illuminance uniformity of the illumination apparatus 100 described in the present embodiment. In particular, if the reference plane cutting the reflection portion 124 to form the parabola U is an x-y plane, the axis center X is the y axis, and the apex of the parabola U is located on the original of the x-y coordinate system, the parabola U may be represented by the equation x²=4*c*y. According to the present embodiment, the distance c from the point light source 130 (the focal point of the parabola U) to the apex of the parabola U ranges from about 0.5 mm to about 3 mm, and the distance W from the apex of the parabola U to the light incident surface 110a ranges from about 10 mm to about 30 mm. The point light source 130 described in the present embodiment is an LED package, for instance, which should not be construed as a limitation to the invention.

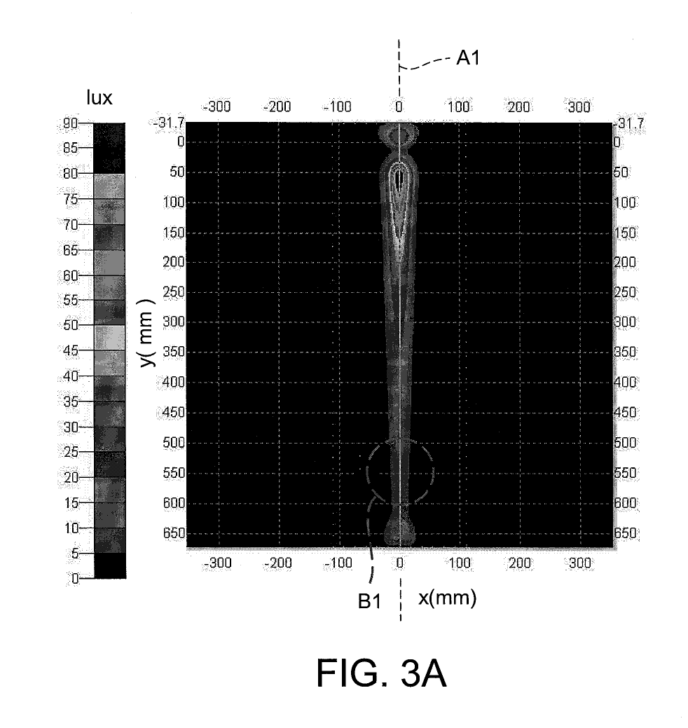

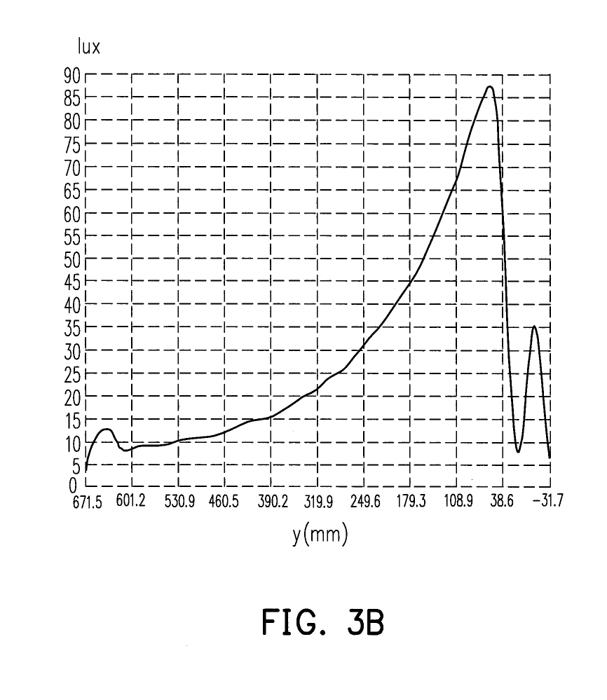

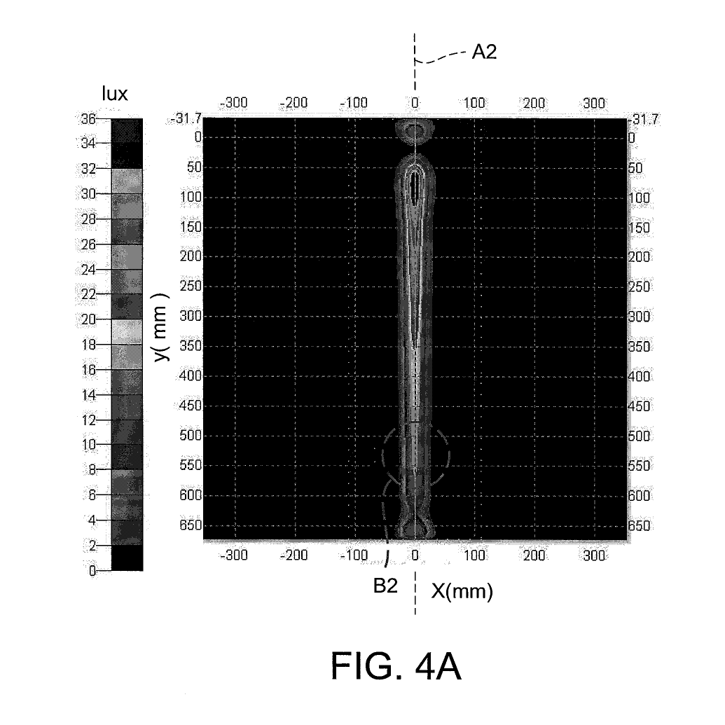

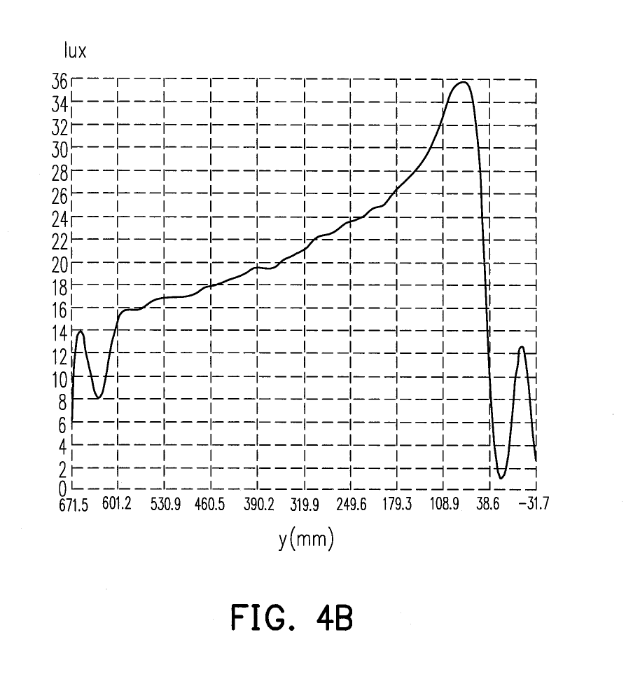

FIG. 3A schematically illustrates illuminance distribution of a conventional illumination apparatus. FIG. 3B schematically and correspondingly illustrates the illuminance distribution along the line segment A1 depicted in FIG. 3A. FIG. 4A schematically illustrates illuminance distribution of an illumination apparatus according to a first embodiment of the invention. FIG. 4B schematically and correspondingly illustrates the illuminance distribution along the line segment A2 depicted in FIG. 4A. With reference to FIG. 3A and FIG. 4A, the x axis denotes locations along the x-axis direction, the y axis denotes locations along the y-axis direction, and each color refers to different illuminance values. The light incident surface 110a of the illumination apparatus 100 described in the present embodiment is located in a end approach the coordinate (0,0) shown in FIG. 3A. According to the result of a comparison between FIG. 3A and FIG. 4A, it can be learned that the illuminance value of the illumination apparatus 100 described in the present embodiment at a place B2 relatively far away from the light incident surface 110a is greater than the illuminance value of the conventional illumination apparatus at a place B2 relatively far away from the light incident surface. Besides, according to FIG. 3B and FIG. 4B, it can be learned that the illuminance of the illumination apparatus 100 described in the present embodiment is reduced to a relatively moderate extent in comparison with the extent of reduction of the illuminance of the conventional illumination apparatus. In other words, the illuminance uniformity of the illumination apparatus 100 described herein is greater than that of the conventional illumination apparatus. To be specific, compared to the illuminance uniformity of the conventional illumination apparatus, the illuminance uniformity of the illumination apparatus 100 described herein is increased by at least 52%.

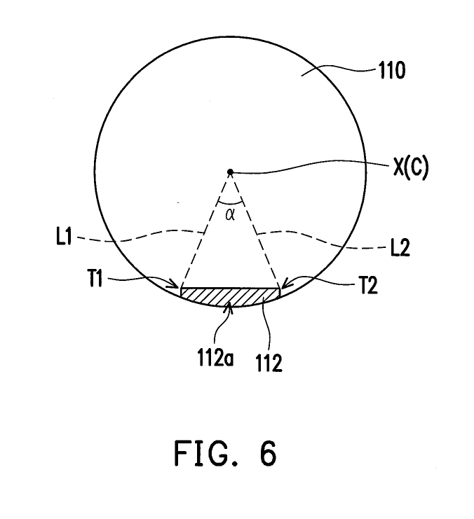

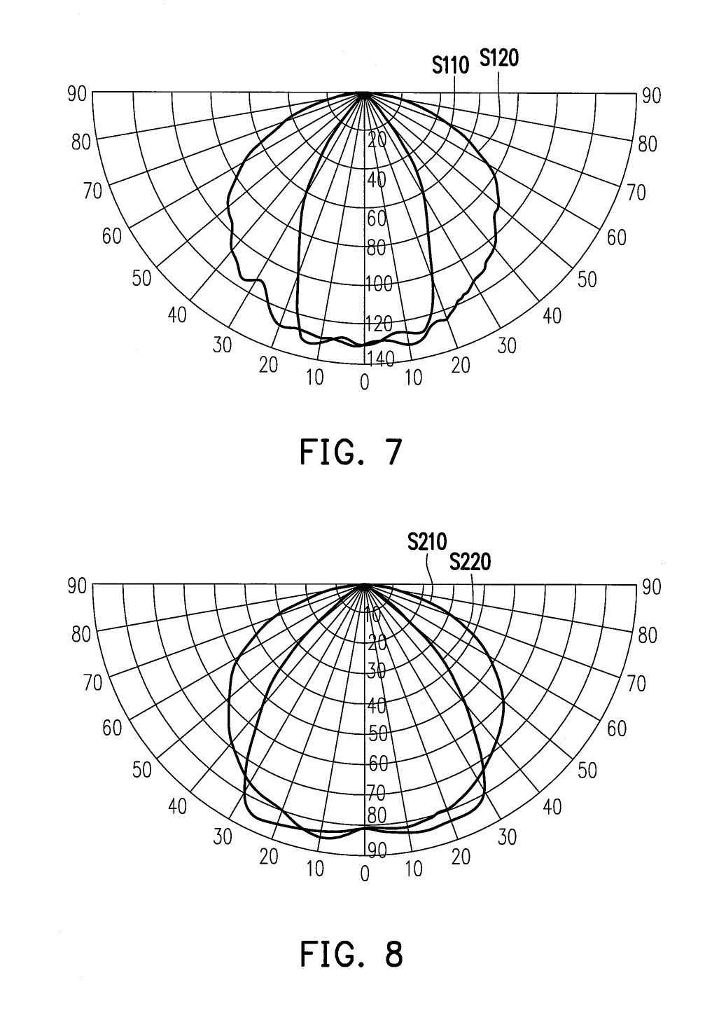

FIG. 6 is a cross-sectional view illustrating the illumination apparatus depicted in FIG. 1. The surface of the paper where FIG. 6 is shown corresponds to the reference plane F depicted in FIG. 1. With reference to FIG. 1 and FIG. 6, the light-guiding pillar 110 has the axis center X. The reference plane F is perpendicular to an extension direction of the axis center X. A center point C(shown in FIG. 6) is obtained by cutting the axis center X with the reference plane F. A cross-sectional plane 112a is obtained by cutting the reflection bar 112 with the reference plane F (i.e., the surface of the paper where FIG. 6 is shown). The cross-sectional plane 112a has a first apex T1 and a second apex T2 respectively located at two sides of the axis center X. The center point C and the first apex T1 are connected to form a first reference line L1. The center point C and the second apex T2 are connected to form a second reference line L2. There is an included angle α between the first reference line L1 and the second reference line L2. If the width of the reflection layer 112 or the included angle α is relatively large, the optical characteristics of the illumination apparatus 100 described in the present embodiment may be more satisfactory. Explanations are exemplarily given below with reference to FIG. 7 and FIG. 8.

FIG. 7 illustrates light pattern distribution of an illumination apparatus according to a comparison example. The difference between the illumination apparatus described in the comparison example and the illumination apparatus 100 described in the present embodiment lies in that the included angle α between the first reference line L1 and the second reference line L2 in the illumination apparatus described in the comparison example is 60°. The curve S110 shown in FIG. 7 denotes the light pattern distribution of the illumination apparatus described in the comparison example along a direction perpendicular to the axis center of the light-guiding pillar, and the curve S120 denotes the light pattern distribution of the illumination apparatus described in the comparison example along a direction parallel to the axis center of the light-guiding pillar. FIG. 8 illustrates light pattern distribution of an illumination apparatus according to an embodiment of the invention. The curve S210 shown in FIG. 8 denotes the light pattern distribution of the illumination apparatus described in an embodiment of the invention along a direction parallel to the axis center of the light-guiding pillar, and the curve S220 denotes the light pattern distribution of the illumination apparatus described in an embodiment of the invention along a direction perpendicular to the axis center of the light-guiding pillar. The difference between the illumination apparatus described in the comparison example and the illumination apparatus 100 depicted in FIG. 8 lies in that the included angle α between the first reference line L1 and the second reference line L2 in the illumination apparatus shown in FIG. 8 is 90°. According to the comparison result between FIG. 7 and FIG. 8, if the included angle α between the first reference line L1 and the second reference line L2 is greater than or substantially equal to 90°, the light distribution range of the illumination apparatus is relatively wide, and the optical characteristics of the illumination apparatus may be more satisfactory.

### Second Embodiment

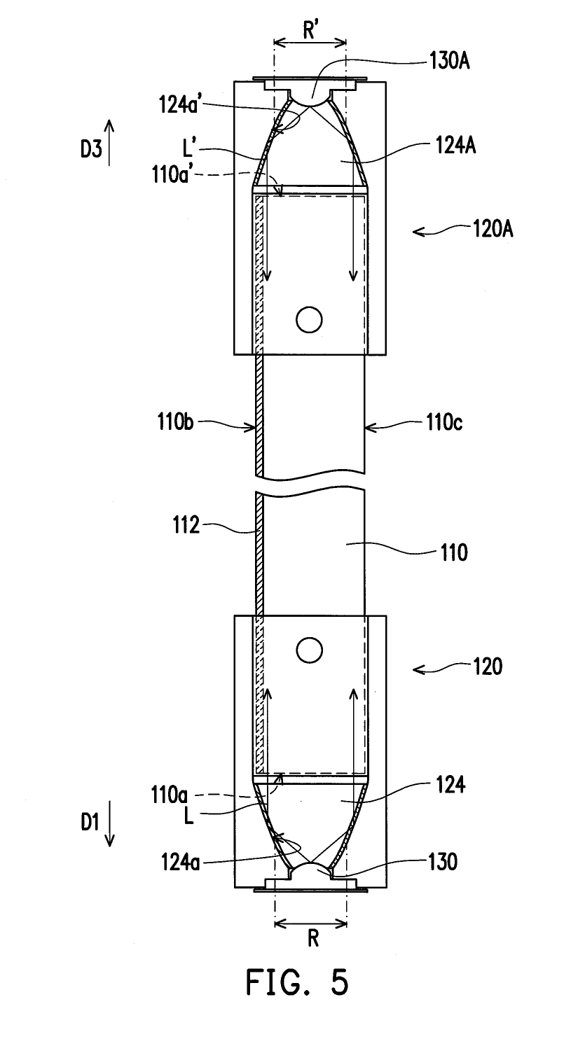

FIG. 5 is a schematic view illustrating an illumination apparatus according to a second embodiment of the invention. The illumination apparatus 100A described in the present embodiment is similar to the illumination apparatus 100 described in the first embodiment, and therefore identical devices in these two embodiments are represented by the same reference numbers. The difference therebetween rests in that the illumination apparatus 100A descried in the present embodiment is equipped with an additional sleeve 120A identical to the sleeve 120 depicted in FIG. 1 and an additional point light source 130A identical to the point light source 130 depicted in FIG. 1. Differences between the two illumination apparatuses 100A and 100 are described hereafter, while similarities thereof are omitted.

With reference to FIG. 5, the illumination apparatus 100A described in the present embodiment includes the light-guiding pillar 110, the sleeve 120, the sleeve 120A, the point light source 130, and the point light source 130A.

The light-guiding pillar 110 has light incident surfaces 110a and 110a′ opposite to each other, a bottom surface 110b, a light-emitting surface 110c opposite to the bottom surface 110b, and a reflection bar 112 disposed on the bottom surface 110b. An extension direction of the reflection bar 112 is substantially parallel to an extension direction of the light-guiding pillar 110. The light incident surface 110a of the light-guiding pillar 110 is disposed in the sleeve 120. The sleeve 120 includes a reflection portion 124. The reflection portion 124 surrounds the light incident surface 110a and extends along a direction D1 away from the light-guiding pillar 110. An internal diameter R of the reflection portion 124 decreases in a direction away from the light incident surface 110a. The light incident surface 110a′ of the light-guiding pillar 110 is disposed in the sleeve 120A. The sleeve 120A includes a reflection portion 124A. The reflection portion 124A surrounds the light incident surface 110a′ and extends along a direction D3 away from the light-guiding pillar 110. An internal diameter R′ of the reflection portion 124A decreases in a direction away from the light incident surface 110a′. The point light source 130 is suitable for emitting a plurality of light beams L. The light beams L are reflected to the light incident surface 110a by an inner surface 124a of the reflection portion 124 and enter the light-guiding pillar 110. After the light beams L enter the light-guiding pillar 110, the light beams L are reflected by the reflection bar 112 and leave the light-guiding pillar 110 from the light-emitting surface 110c. The point light source 130A is suitable for emitting a plurality of light beams L′, and the light beams L′ are reflected to the light incident surface 110a′ by an inner surface 124a′ of the reflection portion 124A and enter the light-guiding pillar 110. After the light beams L′ enter the light-guiding pillar 110, the light beams L′ are reflected by the reflection bar 112 and leave the light-guiding pillar 110 from the light-emitting surface 110c.

In the illumination apparatus 100A described in the present embodiment, the light beams L and L′ emitted by the two point light sources 130 and 130A respectively enter the light-guiding pillar 110 through the reflection portions 124 and 124A from two ends of the light-guiding pillar 110. The illuminance distribution of the two point light sources 130 and 130A through the light-guiding pillar 110 may be overlapped and may be complementary to each other. Hence, compared to the illumination apparatus 100 described in the first embodiment, the illumination apparatus 100A described herein has higher illuminance and more favorable illuminance uniformity. Moreover, the conventional issue of dark zones around the center of the light-guiding pillar may be largely resolved.

The structures derived from the sleeve, the detailed arrangement of the point light source, and other technical features described in the first embodiment are also applicable to the present embodiment, and similar effects may be accomplished in the present embodiment. Hence, no further description is provided hereinafter.

To sum up, through the sleeve having the internal diameter that decreases in a direction away from the light incident surface, the illumination apparatus described in an embodiment of the invention may converge a portion of the light beams emitted from the point light source, such that the light beams enter the light-guiding pillar at a relatively small incident angle. Thereby, the transmission distance of the light beam within the light-guiding pillar is more likely to be increased, and thus the light beam may leave the light-guiding pillar through a region of the light-emitting surface which is relatively far away from the light incident surface. At the same time, other portions of light beams may still leave the light-guiding pillar through a region of the light-emitting surface which is relatively close to the light incident surface. As such, the illuminance uniformity of the illumination apparatus described in an embodiment of the invention may be enhanced.

Although the invention has been disclosed above by the embodiments, they are not intended to limit the invention. Anybody skilled in the art can make some modifications and alteration without departing from the spirit and scope of the invention. Therefore, the protecting range of the invention falls in the appended claims.

What is claimed is:

1. An illumination apparatus comprising:
a light-guiding pillar having a light-emitting surface, a bottom surface opposite to the light-emitting surface, at least one light incident surface adjoining the light-emitting surface and the bottom surface, and a reflection bar disposed on the bottom surface, an extension direction of the reflection bar being substantially parallel to an extension direction of the light-guiding pillar;
at least one sleeve, the at least one light incident surface of the light-guiding pillar being disposed in the at least one sleeve, the at least one sleeve comprising a reflection portion, the reflection portion surrounding the at least one light incident surface and extending along a direction away from the light-guiding pillar, wherein an internal diameter of the reflection portion decreases in a direction away from the at least one light incident surface; and
at least one point light source suitable for emitting a plurality of light beams, wherein a portion of the light beams are reflected to the at least one light incident surface by an inner surface of the reflection portion and enter the light-guiding pillar, and the light beams are reflected by the reflection bar and leave the light-guiding pillar from the light-emitting surface.

2. The illumination apparatus as recited in claim 1, wherein a cross-sectional line obtained by cutting the reflection portion with a reference plane is a portion of a parabola, and an axis center of the light-guiding pillar is located on the reference plane.

3. The illumination apparatus as recited in claim 2, wherein the at least one point light source is located at a focal point of the parabola.

4. The illumination apparatus as recited in claim 1, wherein the at least one sleeve further comprises a metal reflection layer, and at least one portion of the metal reflection layer covers the inner surface of the reflection portion.

5. The illumination apparatus as recited in claim 1, wherein the at least one sleeve further comprises a coupling portion connected to the reflection portion, and the light-guiding pillar is disposed in the coupling portion.

6. The illumination apparatus as recited in claim 5, wherein the at least one point light source is disposed at one end of the reflection portion not connected to the coupling portion.

7. The illumination apparatus as recited in claim 1, wherein a length of the light-guiding pillar is greater than or substantially equal to 50 centimeters.

8. The illumination apparatus as recited in claim 1, wherein the light-guiding pillar has an axis center, a reference plane is perpendicular to an extension direction of the axis center, a center point is obtained by cutting the axis center with the reference plane, a cross-sectional plane is obtained by cutting the reflection bar with the reference plane, the cross-sectional plane has a first apex and a second apex respectively located at two sides of the axis center, the center point and the first apex are connected to form a first reference line, the center point and the second apex are connected to form a second reference line, and an included angle between the first reference line and the second reference line is greater than or substantially equal to 90°.

9. An illumination apparatus comprising:
a light-guiding pillar having a light-emitting surface, a bottom surface opposite to the light-emitting surface, a first and second light incident surfaces adjoining the light-emitting surface and the bottom surface, and a reflection bar disposed on the bottom surface, the first light incident surface being opposite to the second light incident surface, an extension direction of the reflection bar being substantially parallel to an extension direction of the light-guiding pillar;
a first sleeve, the first light incident surface of the light-guiding pillar being disposed in the first sleeve, the first sleeve comprising a first reflection portion, the first reflection portion surrounding the first light incident surface and extending along a direction away from the light-guiding pillar, wherein an internal diameter of the first reflection portion decreases in a direction away from the first light incident surface;
a second sleeve, the second light incident surface of the light-guiding pillar being disposed in the second sleeve, the second sleeve comprising a second reflection portion, the second reflection portion surrounding the second light incident surface and extending along a direction away from the light-guiding pillar, wherein an internal diameter of the second reflection portion decreases in a direction away from the second light incident surface;
a first point light source suitable for emitting a plurality of first light beams, wherein a portion of the first light beams are reflected to the first light incident surface by an inner surface of the first reflection portion and enter the light-guiding pillar, and the first light beams are reflected by the reflection bar and leave the light-guiding pillar from the light-emitting surface; and
a second point light source suitable for emitting a plurality of second light beams, wherein a portion of the second light beams are reflected to the second light incident surface by an inner surface of the second reflection portion and enter the light-guiding pillar, and the second light beams are reflected by the reflection bar and leave the light-guiding pillar from the light-emitting surface.

10. The illumination apparatus as recited in claim 9, wherein a length of the light-guiding pillar is greater than or substantially equal to 100 centimeters.

11. The illumination apparatus as recited in claim 9, wherein the light-guiding pillar has an axis center, a reference plane is perpendicular to an extension direction of the axis center, a center point is obtained by cutting the axis center with the reference plane, a cross-sectional plane is obtained by cutting the reflection bar with the reference plane, the cross-sectional plane has a first apex and a second apex respectively located at two sides of the axis center, the center point and the first apex are connected to form a first reference line, the center point and the second apex are connected to form a second reference line, and an included angle between the first reference line and the second reference line is greater than or substantially equal to 90°.
